(19) United States
(12) Patent Application Publication
(10) Pub. No.: US 2014/0015431 A1
(43) Pub. Date: Jan. 16, 2014

(54) ILLUMINATION APPARATUS AND METHOD

(71) Applicant: Thomas Quirk, Liverpool Merseyside (GB)

(72) Inventor: Thomas Quirk, Liverpool Merseyside (GB)

(73) Assignee: New Lighting Technology Limited, Liverpool Merseyside (GB)

(21) Appl. No.: 13/879,493

(22) PCT Filed: Oct. 14, 2011
(86) PCT No.: PCT/GB2011/051994

§ 371 Date: Sep. 30, 2013

(30) Foreign Application Priority Data
Oct. 15, 2010 (GB) 1017462.1

(51) Int. Cl. H05B 33/08

(52) U.S. Cl. CPC H05B 33/08
USPC 315/201

(57) ABSTRACT

An illumination apparatus is described which comprises a solid state light emitting device and means for powering the light emitting device. The powering means is adapted to provide a series of pulses, wherein each pulse comprises a substantially square waveform followed by a decaying oscillating waveform.

The present invention relates apparatus for illuminating light emitting devices, particularly solid state devices such as light emitting diodes. The present invention further extends to a method of illuminating such devices.

### SUMMARY OF THE INVENTION

According to the present invention there is provided, an illumination apparatus, comprising: a solid state light emitting device; and means for powering the light emitting device, the powering means adapted to provide a series of pulses, wherein each pulse comprises a substantially (within 90%) square waveform followed by a decaying oscillating waveform. By providing a series of pulses each pulse comprising a substantially square waveform followed by a decaying oscillating waveform the efficiency of the illuminating apparatus may be improved.

Preferably, the amplitude of the decaying oscillating waveform is between 10% and 30% of the amplitude of each pulse, preferably between 15% and 25%.

Preferably, the decaying oscillating waveform decays linearly or exponentially.

Preferably, the time taken for said decaying oscillating waveform to decay to substantially zero (within 0.5v) being between 1 and 3 times the period of each pulse, preferably between 1.5 and 2.5 times, as such the light emitted by the light emitting device may appear to be substantially constant to a user.

Preferably, the decaying oscillating waveform alternates between positive and negative voltage.

Preferably, the series of pulses comprises first and second pulses, wherein the pulse width of the first pulse is less than the pulse width of the second pulse. By providing such a series of pulses the efficiency of the apparatus may be further improved. More preferably, the first pulse width is less than 50% of the second pulse width.

Preferably, the time taken for said decaying oscillating waveform to decay to substantially zero being substantially equal for said first and second pulses.

Preferably, the peak of said substantially square wave comprises an oscillating waveform. More preferably, the oscillating waveform decays.

Preferably, the frequency of said series of pulses is between 500 and 1000 pulses/minute. More preferably, the frequency is between 600 and 900 pulses/minute, yet more preferably between 700 and 800 pulses/minute, more preferably between 730 and 750 pulses/minute.

Preferably, the powering means is adapted to illuminate said light emitting device such that, in use, it appears to emit substantially constant light when viewed by a user.

Preferably, the powering means is adapted to illuminate said light emitting device such that, in use, it appears to emit substantially constant light when viewed by a user.

Preferably, the light emitting device being at least one light emitting diode.

Preferably, the input to said powering means being a DC power supply. More preferably, the powering means further comprising a rectifier adapted rectify an AC power supply to generate said DC input.

Preferably, the input is substantially 24v.

Preferably, the powering means is a hybrid power supply of solar power, and mains AC. More preferably, the solar power is utilized when sufficient solar power is available to operate said light emitting device, and said mains AC is utilized if said solar power is not sufficient.

Preferably, the illumination apparatus further comprises a battery holder connected to the powering means. More preferably, the solar power is adapted to charge a battery within the battery holder when said light emitting device is not in use, the battery within the battery holder being utilized to power said light emitting device when said solar power is not sufficient.

Preferably, the illumination apparatus further comprises a processor, and associated memory, adapted to be remotely programmable, said processor being adapted to control the waveform of said series of pulses. More preferably, the illumination apparatus further comprises means for remotely programming said processor. Yet more preferably, the remote programming means includes at least one of: a USB connection, a PFI slot, and a wireless transceiver.

According to a further aspect of the present invention there is provided a method of illuminating a light emitting device, comprising: powering the light emitting device, the powering means adapted to provide a series of pulses, wherein each pulse comprises a substantially square waveform followed by a decaying oscillating waveform.

The invention also provides a computer program and a computer program product comprising software code adapted, when executed on a data processing apparatus, to perform any of the methods described herein, including any or all of their component steps.

The invention extends to methods and/or apparatus substantially as herein described with reference to the accompanying drawings.

Apparatus and method features may be interchanged as appropriate, and may be provided independently one of another. Any feature in one aspect of the invention may be applied to other aspects of the invention, in any appropriate combination. In particular, method aspects may be applied to apparatus aspects, and vice versa.

### BRIEF DESCRIPTION OF THE DRAWINGS

Embodiments of this invention will now be described, by way of example only, with reference to the accompanying drawings, of which:

FIG. 1 shows a schematic diagram of an illumination apparatus for powering a solid state light emitting device;

FIG. 2 shows a schematic diagram of a pulse unit utilized to power a light emitting diode (LED);

FIG. 3 shows a typical pulse waveform used to power the LED;

FIG. 4 shows a further schematic diagram of an illumination apparatus;

FIGS. 5a and 5b show a detailed circuit diagram of a system utilized to power four LEDs; and

FIGS. 6a to 6d show a detailed circuit diagram of a system utilized to power 10 LEDs.

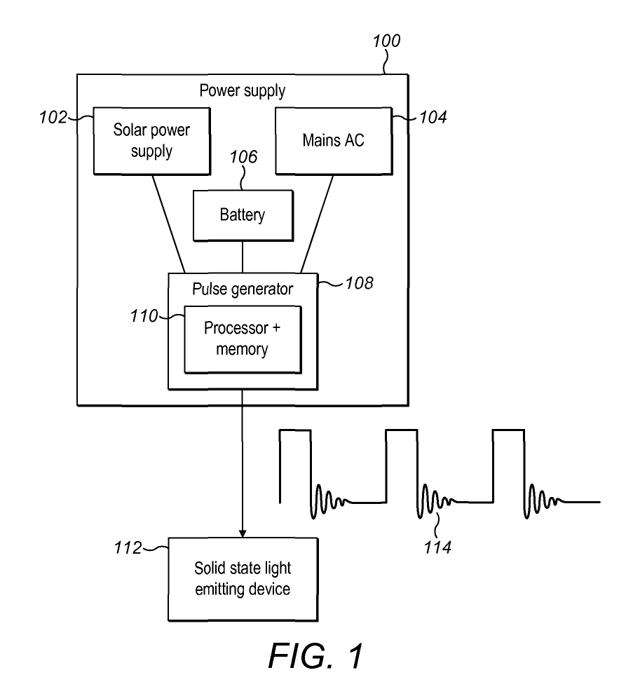

FIG. 1 shows a schematic diagram of an illumination apparatus for powering a solid state light emitting device. The power supply 100 comprises a solar power supply 102, a mains AC power supply 104 and a battery 106 that are all adapted to provide power to a pulse generator 108. The pulse generator 108 comprises a processor and associated memory 110 that is adapted to control the pulse generator and determines the waveform outputted by the power supply 100. The power supply provides power to a solid state light emitting device 112, such as an LED.

The pulse generator 108 provides a waveform as shown by 114. As can be seen the waveform is a series of positive pulses in essence in the form of a square wave. However, each pulse has a tail that oscillates about zero and decays to zero before the next pulse in the series. The amplitude of each tail is approximately 20% of the amplitude of the pulse. The pulsed waveform in conjunction with the decaying oscillating tail is provided in order to illuminate the LED in such as way that the user can not detect any flickering of the light, i.e. the light appears to be continuous. In addition, the illumination provided appears to be continuous even when recorded on a standard video camera, such as those commonly used in CCTV. In order to achieve such an apparently continuous light the frequency of the pulses is approximately 740 pulses/minute. The pulsed waveform allows the overall efficiency of the LED illumination system to be increased as the total power provided to the LED is reduced. In addition, and most importantly, the junction temperature of the LED remains lower than the junction temperature of the same LED powered by a constant power supply. Reducing the temperature of the junction of the LED increases the efficiency of the LED—i.e. the same amount of light is output for less power input. In addition to increasing the efficiency, reducing the junction temperature also increases the life expectancy of the LED.

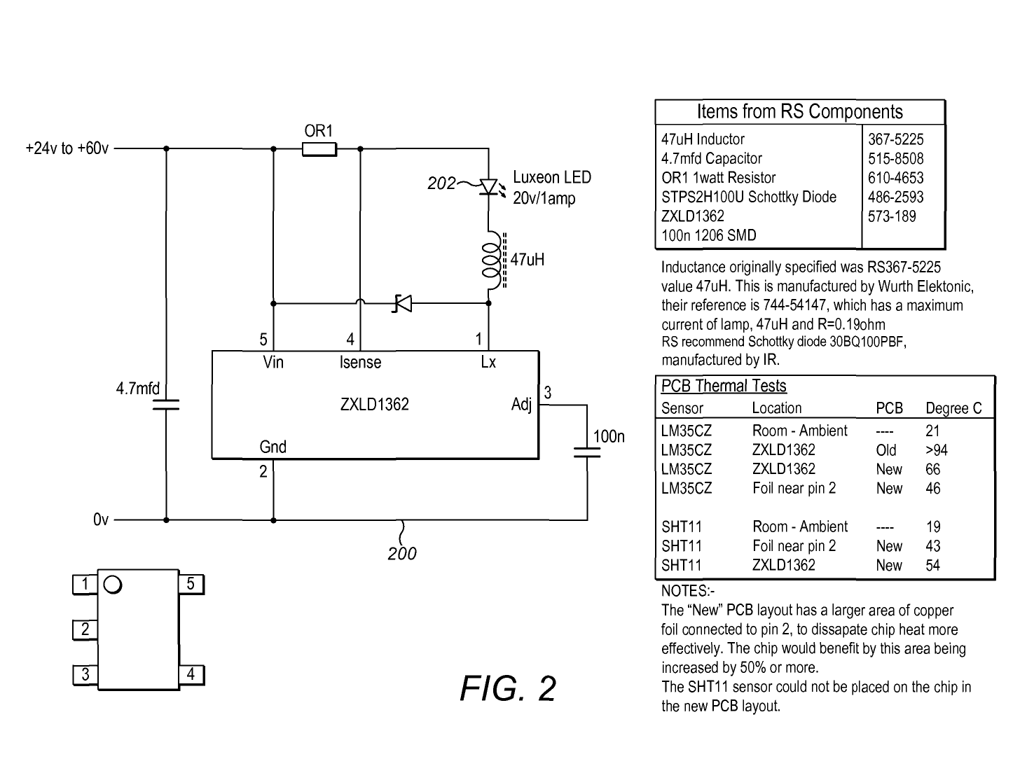

FIG. 2 shows a schematic diagram of a pulse unit utilized to power a light emitting diode (LED). The pulse unit 200 is adapted to receive DC power and convert that input into a pulsed output to provide the LED 202 with the pulsed waveform as described above. The processor, a ZXLD range regulator semi-conductor, includes an output switch and a high-side output current sensing circuit which uses an external resistor to set the nominal average output current. The output current may be adjusted above, or below the set value, by applying an external control signal to the ‘ADJ’ pin. The ADJ pin will accept either a DC voltage or a pulse-width-modulation (PWM) waveform. Depending upon the control frequency, this will provide either a continuous (dimmed) or a gated output current, the gated (pulsed) output current can then be regulated via resistance, capacitor and inductance control, enabling the required pulsing frequencies to be generated.

PWM enables digital encoding of analog signal levels. Through the use of high-resolution counters the duty cycle of a square wave is modulated to encode a specific analog signal level. However, the PWM signal remains digital since, at any given instant of time, the full DC supply is either fully on or fully off. The voltage, or current, source is supplied to the analog load by means of a repeating series of on and off pulses. The on-time is the time during which the DC supply is applied to the load, and the off-time is the period during which that supply is switched off. This enables regulation of the driver system to meet the requirements for a square wave pulse and allows the pulse to be controlled to provide the specific pulse frequency and riffle required.

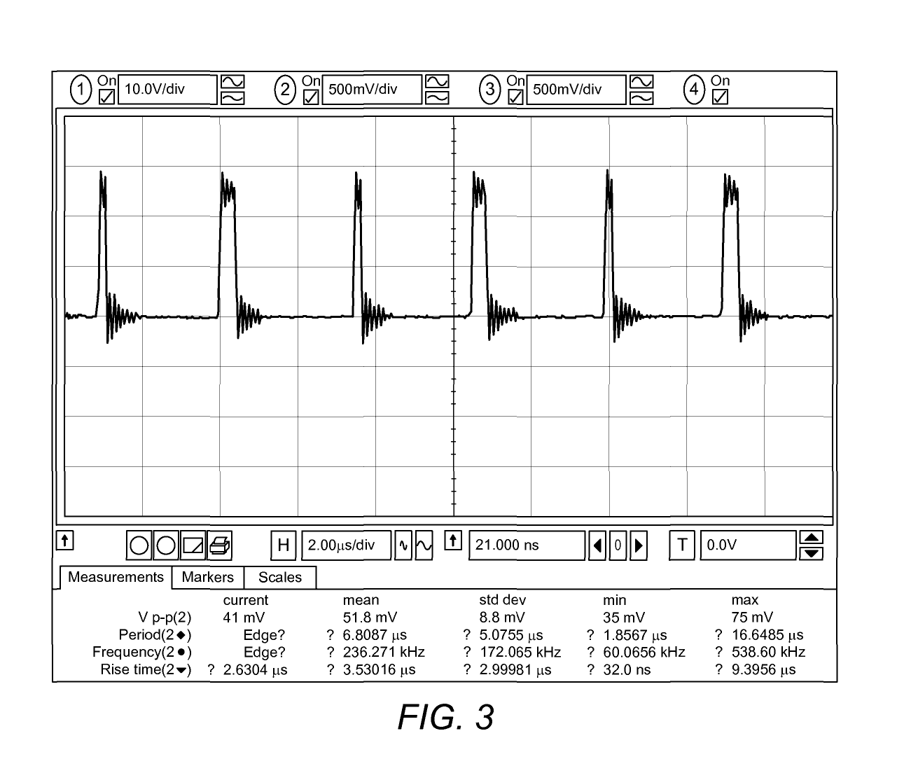

FIG. 3 shows a typical pulse waveform used to power the LED. As can be seen the pulsed waveform is similar to that of 114 shown in FIG. 1. However, it can be seen that the pulsed waveform comprises a series of first and second pulses, the first pulse being approximately 50% of the width of the second pulses. Thus the power consumption of the system may be further reduced but the apparent constant light output of the LED may be maintained. In addition, at the peak of each pulse the power is oscillated about what would be the top of the square waveform; this again is in order to maintain the illusion of constant light provided to a user. Finally, the approximate peak voltage of each pulse is 24v; however it should be understood that the system can easily be adapted to power any appropriate solid state light emitting device at any appropriate voltage.

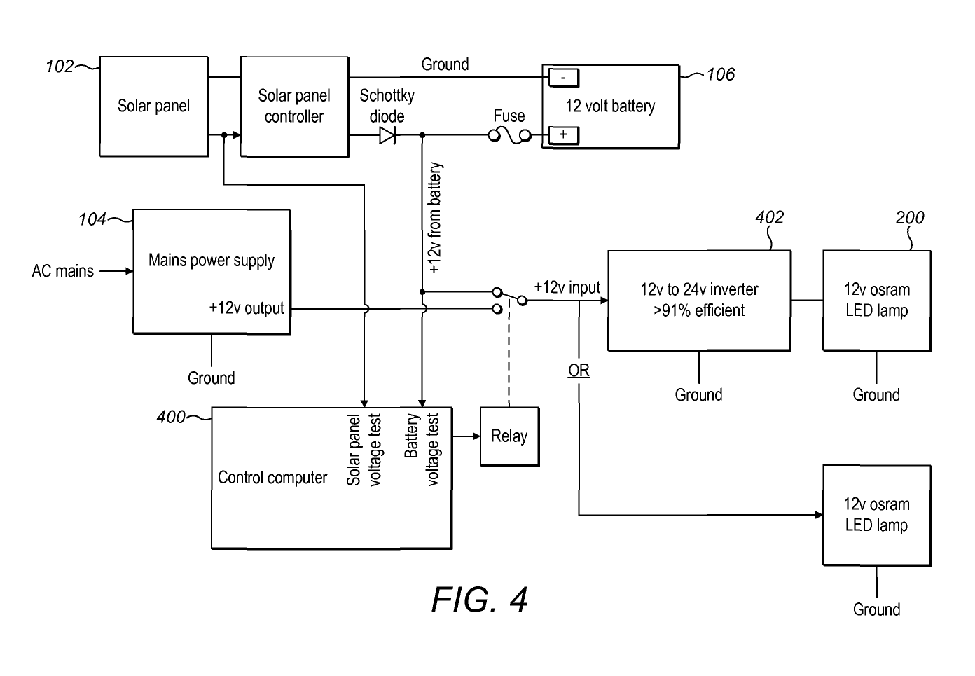

FIG. 4 shows a further schematic diagram of an illumination apparatus as shown in FIG. 1. FIG. 4 shows further details associated with the illumination apparatus. The solar panel 102, mains AC 104 and battery 106 are connected via a control computer 400 adapted to control the input source of power to the LED and its associated controller 200. If required, an inverter 402 can be utilized to invert a 12v input to 24v. In this example, the primary power source is solar power, and the other sources of power are utilized when the solar power is not sufficient. The control computer 400 can measure a test voltage from the solar panel and will change over the power source to the mains AC when the voltage is too low to operate the LED. The mains AC power source will then be utilized for at least a fixed period of time, say, 8 hours, to allow the solar panel to provide sufficient charge to the battery, thus enabling the solar power to be utilise to power the LEDs once more.

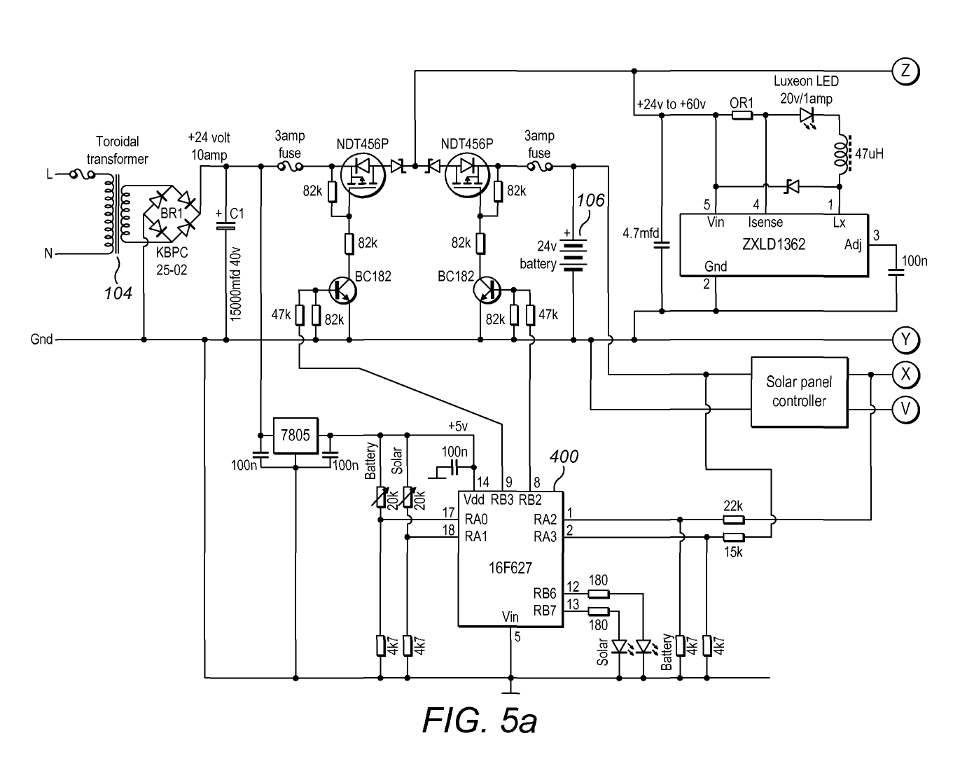

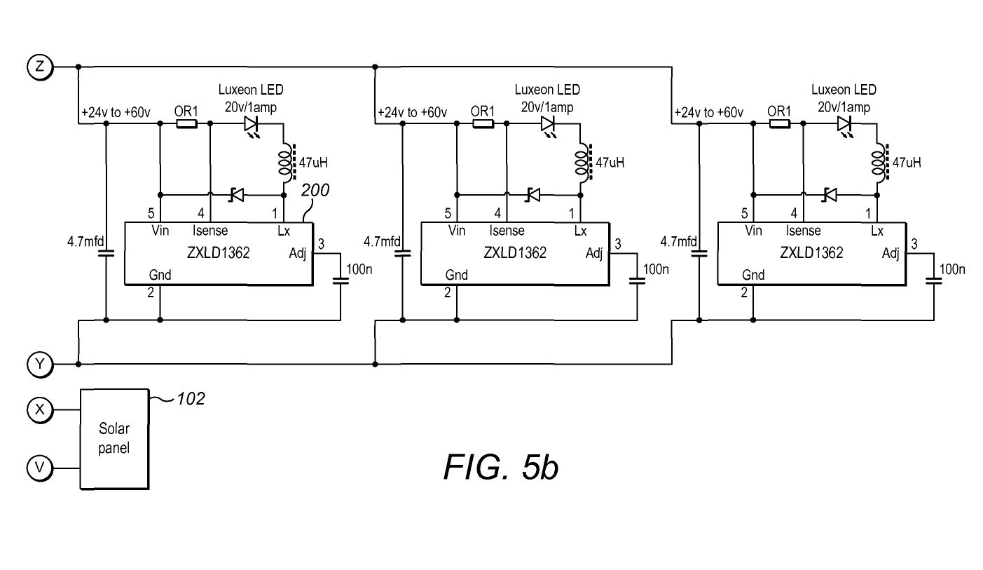

FIG. 5 shows a detailed circuit diagram of a system utilized to power four LEDs. The system is similar to that shown in FIG. 4 and comprises the same components. However, the system is adapted to power four LED modules 200, and as described above the LEDs themselves are powered using the pulsed waveform.

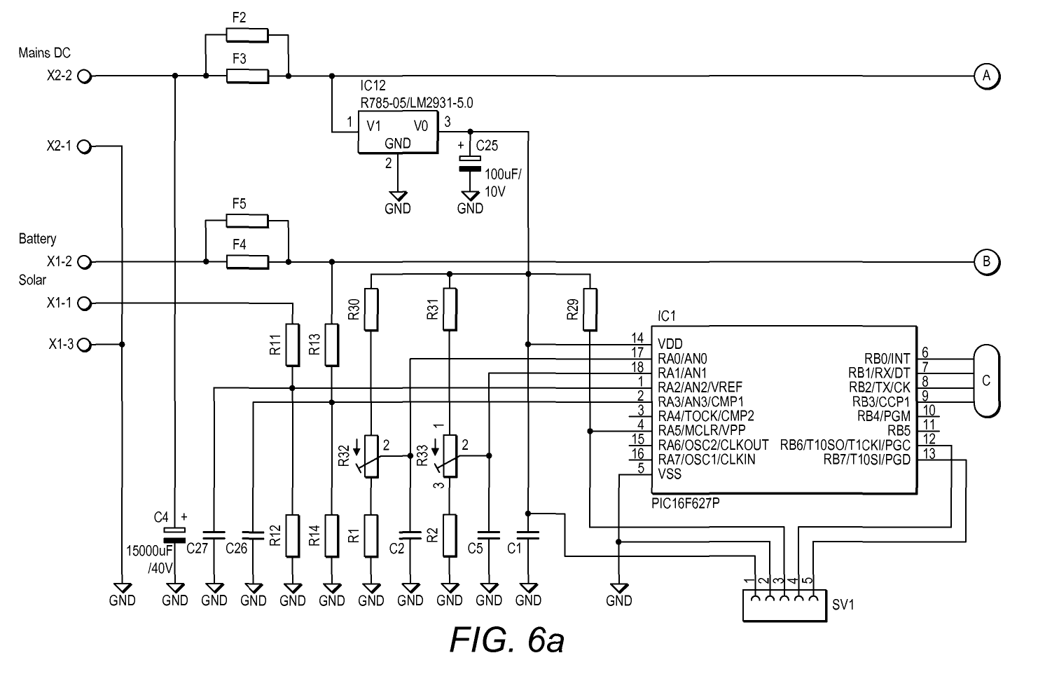

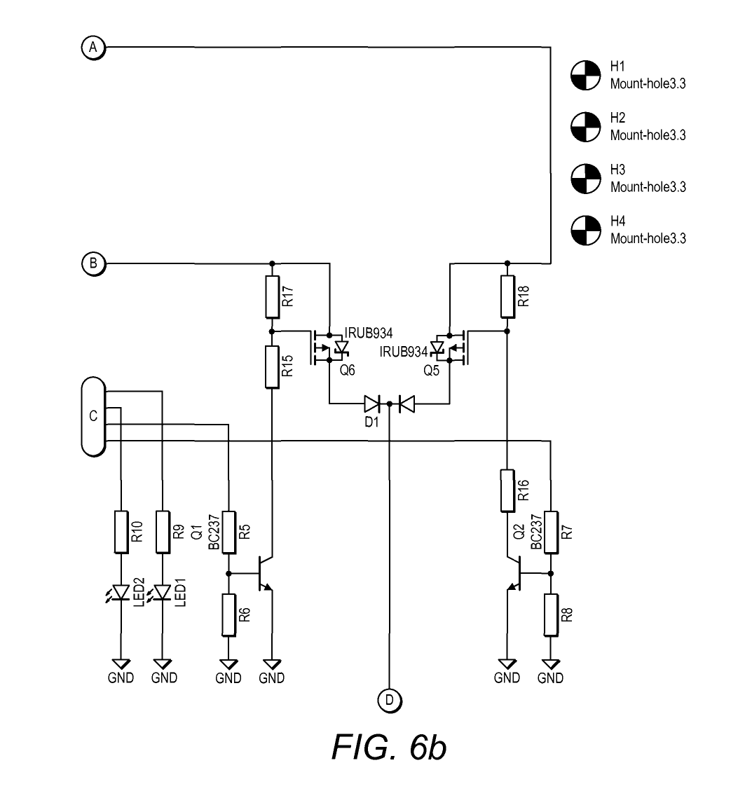

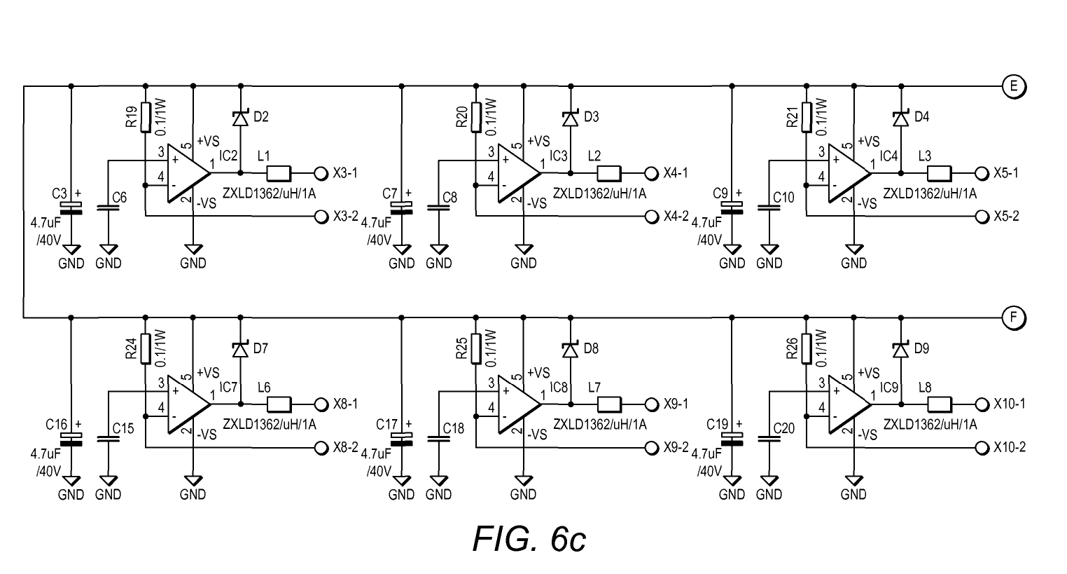

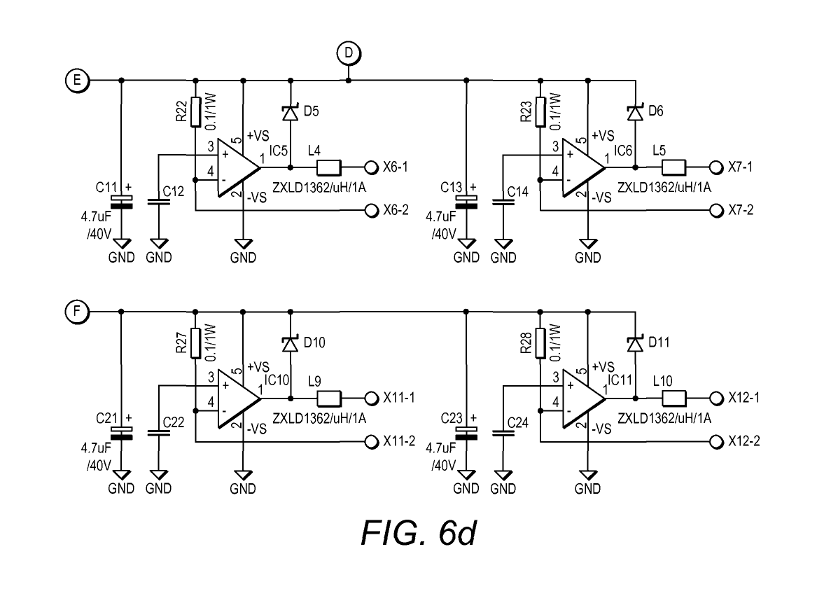

FIG. 6 is a detailed circuit diagram of a system utilized to power 10 LEDs, and has the same components as described in FIGS. 4 and 5.

The computer controller 400, further comprises a transceiver or the like that enables the controller software/firmware to be remotely updated. In this way, the output maybe controlled to further optimise the use of the power available. The remote update can be undertaken over a USB connection, via a PFI slot (pin), or via wireless, such as the IEEE 802.11 protocol and its variants.

It is of course to be understood that the invention is not intended to be restricted to the details of the above embodiments which are described by way of example only, and modifications of detail can be made within the scope of the invention.

Each feature disclosed in the description, and (where appropriate) the claims and drawings may be provided independently or in any appropriate combination.

1. An illumination apparatus, comprising:
a solid state light emitting device; and
means for powering the light emitting device, the powering means being adapted to provide a series of pulses, wherein each pulse comprises a substantially square waveform followed by a decaying oscillating waveform.

2. The illumination apparatus according to claim 1, wherein the amplitude of said decaying oscillating waveform is between 10% and 30% of the amplitude of each said pulse.

3. The illumination apparatus according to claim 1, wherein said decaying oscillating waveform decays linearly.

4. The illumination apparatus according to claim 1, wherein said decaying oscillating waveform decays exponentially.

5. The illumination apparatus according to claim 1, wherein the time taken for said decaying oscillating waveform to decay to substantially zero is between 1 and 3 times the period of each pulse.

6. The illumination apparatus according to claim 1, wherein said decaying oscillating waveform alternates between positive and negative voltage.

7. The illumination apparatus according to claim 1, wherein said series of pulses a first and second pulse, wherein the pulse width of the first pulse is less than the pulse width of the second pulse.

8. The illumination apparatus according to claim 7, wherein said first pulse width is less than 50% of the second pulse width.

9. The illumination apparatus according to claim 7 wherein the time taken for said decaying oscillating waveform to decay to substantially zero is substantially equal for said first and second pulses.

10. The illumination apparatus according to claim 1, wherein the peak of said substantially square wave comprises an oscillating waveform.

11. The illumination apparatus according to claim 10, wherein said oscillating waveform decays.

12. The illumination apparatus according to claim 1, wherein the frequency of said series of pulses is at least one of: between 500 and 1000 pulses/minute: between 600 and 900 pulses/minute: between 700 and 800 pulses/minute: and between 730 and 750 pulses/minute.

13. (canceled)

14. (canceled)

15. The illumination apparatus according to claim 1, wherein said powering means is adapted to illuminate said light emitting device such that, in use, it appears to emit substantially constant light when viewed by a user.

16. The illumination apparatus according to claim 1, wherein said light emitting device is at least one light emitting diode.

17. The illumination apparatus according to claim 1, wherein the input to said powering means comprises at least one of: a DC power supply; a rectifier adapted to rectify an AC power supply to generate a DC input; a hybrid power supply of solar power, and mains AC.

18. (canceled)

19. The illumination apparatus according to claim 17, wherein said input is substantially 24V.

20. (canceled)

21. The illumination apparatus according to claim 1, wherein said powering means is a hybrid power supply of solar power, and mains AC and said solar power is utilized when sufficient solar power is available to operate said light emitting device, and said mains AC is utilized if said solar power is not sufficient.

22. (canceled)

23. The illumination apparatus according to claim 21, wherein said solar power is adapted to charge a battery when said light emitting device is not in use.

24. The illumination apparatus according to claim 21, wherein a battery is utilized to power said light emitting device when said solar power is not sufficient.

25. The illumination apparatus according to claim 1, further comprising a processor, and associated memory, adapted to be remotely programmable, said processor being adapted to control the waveform of said series of pulses.

26. The illumination apparatus according to claim 25, further comprising means for remotely programming said processor.

27. The illumination apparatus according to claim 26, wherein said remote programming means includes at least one of: a USB connection, a PFI slot, and a wireless transceiver.

28. A method of illuminating a light emitting device, comprising:
powering the light emitting device, the powering means adapted to provide a series of pulses, wherein each pulse comprises a substantially square waveform followed by a decaying oscillating waveform.

29. (canceled)

30. (canceled)
